(19) United States
(12) Patent Application Publication
(10) Pub. No.: US 2003/0094561 A1
(43) Pub. Date: May 22, 2003

(54) Personal accessory carrying apparatus

(76) Inventor: Waddell K. Fields, Suwanee, GA (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/144,465

(22) Filed: May 13, 2002

Related U.S. Application Data
(63) Continuation-in-part of application No. 09/991,375, filed on Nov. 16, 2001.

(51) Int. Cl. F16M 11/00; A47G 29/00

(52) U.S. Cl. 248/690; 248/682

(57) ABSTRACT

A carrying device enabling hands-free transporting of a personal data assistant, cellular telephone, pager or other personal accessory wherein a clipping mechanism removably secures the device to a user and a resiliently wound mechanism acts to enable comfortably adjustable, securely linked access to a personal accessory, thereby providing hands-free carrying and virtually eliminating risk of loss from accidental misplacement.

### PRIORITY CLAIM

The present non-provisional application is a continuation-in-part of pending application Ser. No. 09/991,375, entitled “Personal Data Assistant Carrying Apparatus,” filed Nov. 16, 2001 and, to the fullest extent permitted by law, claims priority to and the benefit thereof.

### TECHNICAL FIELD

The present invention relates generally to accessory carrying devices and, more specifically, to a carrying device enabling hands-free transporting of a personal data assistant, cellular telephone, pager or other accessory, providing easy accessibility thereto and preventing accidental misplacement thereof. The present invention is particularly useful in, although not strictly limited to, applications desiring protection of a personal electronic device from accidental loss following use thereof, especially while traveling.

### BACKGROUND OF THE INVENTION

Modern lifestyle often necessitates busy and complex schedules for all ages. As a result, personal calendars, diaries and other scheduling aides have become commonplace. Recent advancements in technology have allowed for the proliferation of portable high-tech scheduling devices. These devices, commonly known as personal data assistants (PDA's), not only offer paper-free calendars but also act as portable data storage and processing units. The versatility and power of the PDA, in combination with its easy portability, have led to a rapid and consistent increase in PDA users.

At present, even more prevalent than portable scheduling and data handling devices are portable communication devices. A growing majority of individuals rely upon cellular telephones and pagers to coordinate their busy lives. Their increasing affordability, accessibility and performance, coupled with decreasing device dimension requirements, has continued to expand the user market.

Typical PDA users are business users. Most, especially those frequently away from the traditional office, place high value on these portable information processing devices. While most PDA's are capable of directly linking to a desktop or laptop computer, it is their capability to work efficiently as a stand-alone device that is the basis of their popularity. As such, the data held within a PDA is often valuable, confidential and many times irreplaceable.

Typical users of portable communication devices are business users, individual users, family users or, simply put, anyone with access. Like PDA's, business users frequently away from the traditional office place an especially high value on these portable communication devices. However, individual or family users find portable communication devices invaluable also. For instance, parents often rely upon pagers or cellular telephones to coordinate childcare pickups, avoiding potentially lengthy and lonely waits for their children. Furthermore, many individuals consider their wireless telephone to be a life-saving device to be relied upon in an emergency situation for the ability to place an emergency call without having to locate a payphone.

Accidental loss of a PDA is, at best, an expensive, time-consuming inconvenience when data can be reconstructed from other sources. The same could be said of a wireless telephone or pager, given the available storage capabilities of phones and pagers. When data is irreplaceable, however, loss of a PDA, phone or pager can be devastating. Furthermore, the loss of a phone can prevent an emergency call in a potentially life threatening situation. The prevention of such a loss, therefore, is of the utmost importance.

Unfortunately, many PDA, phone and pager users are frequent business travelers who find themselves working at a variety of makeshift locations. The small size of these devices, a benefit providing for easy portability, detrimentally makes them easy to overlook and forget. Even the most organized individuals occasionally walk away and mistakenly leave personal property items behind. For these essential devices, such an error must be prevented.

Therefore, it is readily apparent that there is a need for a personal accessory carrying device enabling easy accessibility and usage thereof, wherein accidental misplacement is prevented and hands-free transportation is provided thus preventing the above-discussed disadvantages.

### BRIEF SUMMARY OF THE INVENTION

Briefly described, in a preferred embodiment, the present invention overcomes the above-mentioned disadvantages, and meets the recognized need for such a device, by providing a personal accessory carrying device wherein a resiliently wound mechanism acts to enable comfortably adjustable linked access to a personal accessory, thereby providing hands-free carrying and virtually eliminating risk of loss from accidental misplacement.

According to its major aspects and broadly stated, the present invention is a personal accessory carrying apparatus, wherein a receiving loop is mounted to the user's personal accessory, the carrying apparatus is removably secured to the personal accessory via the receiving loop and a clipping mechanism removably secures the carry apparatus to the user.

More specifically, the present invention is a personal accessory carrying device adapted to be worn by a user, wherein a personal accessory is secured thereto and resilient access is provided thereby.

A feature and advantage of the present invention is the ability of such a device to provide a personal accessory carrying device that is simple in construction and thus easy to manufacture.

A feature and advantage of the present invention is the ability of such a device to provide hands-free carrying of a PDA, cellular telephone, pager, wallet or other personal accessory.

A feature and advantage of the present invention is the ability of such a device to prevent accidental misplacement of a personal accessory.

A feature and advantage of the present invention is the ability of such a device to allow easy user-accessibility to a personal accessory.

A feature and advantage of the present invention is the ability of such a carrying device to resiliently link a personal accessory to a user.

A feature and advantage of the present invention is to provide a device that prevents the dropping, slipping or falling of a personal accessory from out of a pocket, a briefcase or one's hands.

A feature and advantage of the present invention is the ability of such a device to allow secure user carriage thereof while preventing limitation of usage locations.

These and other objects, features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a front perspective view of a personal accessory carrying device according to a preferred embodiment of the present invention.

FIG. 2 is a rear perspective view of a personal accessory carrying device according to a preferred embodiment of the present invention.

FIG. 3 is a side perspective view of a personal accessory carrying device according to a preferred embodiment of the present invention.

FIG. 4 is a perspective view of a personal accessory carrying device according to a preferred embodiment of the present invention showing the device in use.

FIG. 5 is a perspective view of a personal accessory carrying device according to a preferred embodiment of the present invention showing the device in use.

FIG. 6 is a rear perspective view of a personal accessory carrying device according to an alternate embodiment of the present invention.

FIG. 7 is a rear perspective view of the personal accessory carrying device of FIG. 6 showing an attached receiving loop positioned for mounting to a cellular telephone.

FIG. 8 is a rear perspective view of a personal accessory carrying device according to an alternate embodiment of the present invention showing an unattached mount.

FIG. 9 is a perspective view of the personal accessory carrying device of FIG. 8 showing an attached mount positioned on a cellular telephone.

FIG. 10 is a front perspective view of a personal accessory carrying device according to an alternate embodiment of the present invention showing a catch hook.

FIG. 11 is a rear perspective view of a personal accessory carrying device according to an alternate embodiment of the present invention showing a catch hook.

FIG. 12 is a front perspective view of a personal accessory carrying device according to an alternate embodiment of the present invention showing a catch hook.

FIG. 13 is a rear perspective view of a personal accessory carrying device according to an alternate embodiment of the present invention showing a catch hook.

### DETAILED DESCRIPTION OF THE PREFERRED AND ALTERNATE EMBODIMENTS

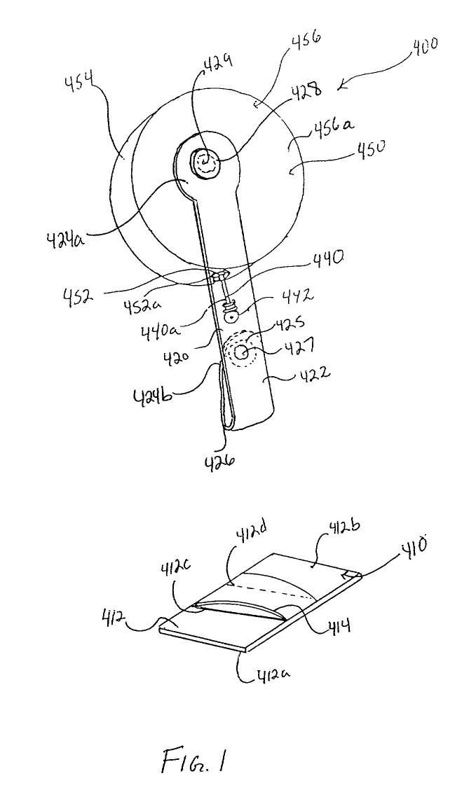

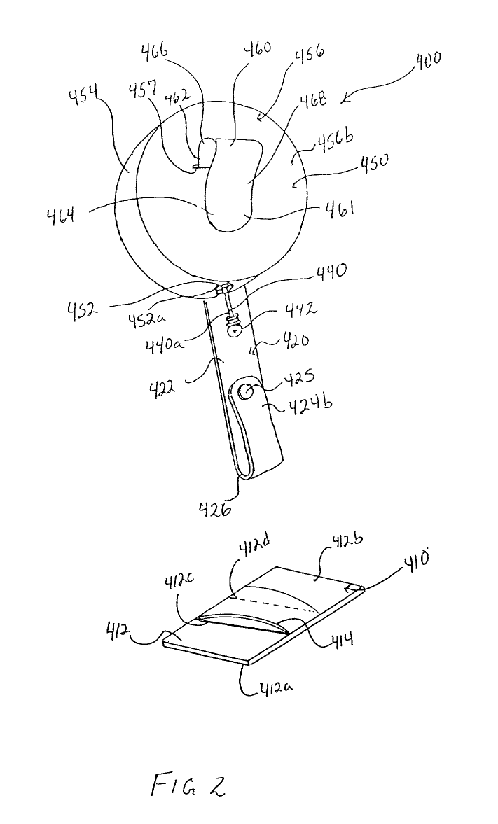

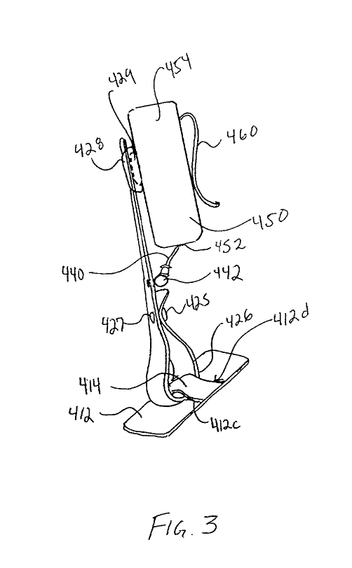

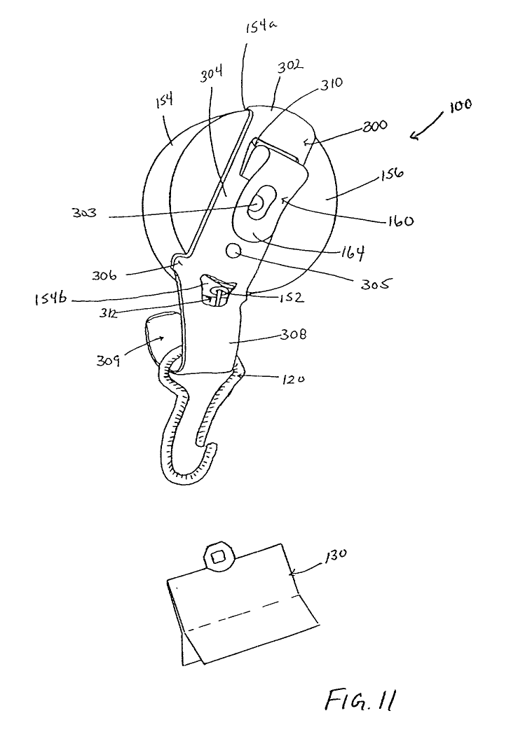

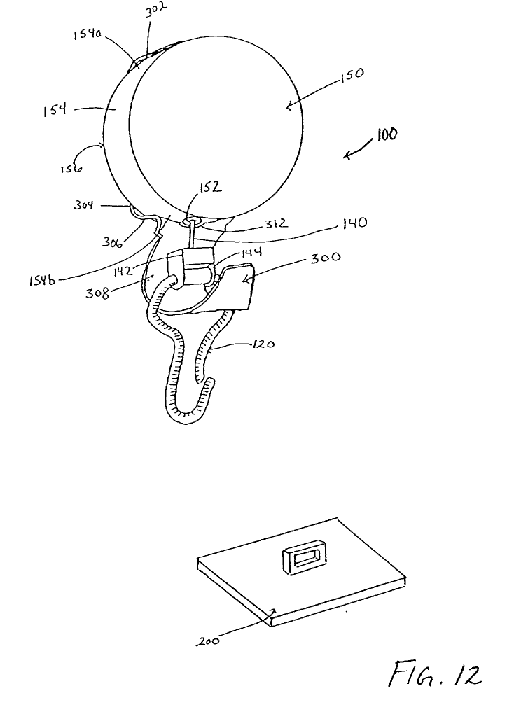

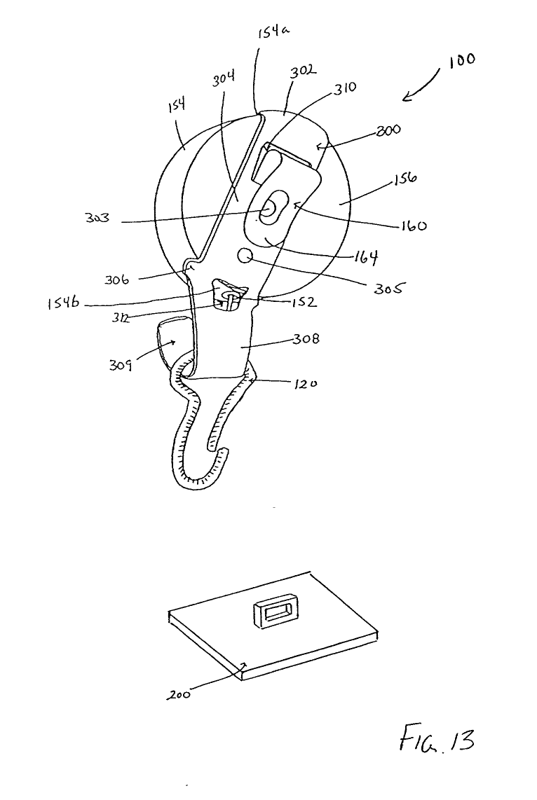

In describing the preferred and alternate embodiments of the present invention, as illustrated in FIGS. 1-13, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-3, the present invention is a personal accessory carrying device 400 comprising mounting means 410, hooking means 420, cable 440, housing 450 and clipping means 460. Mounting means 410 is preferably a substantially flat, substantially rectangular shaped pad 412, having adhesive lower surface 412a and preferably non-adhesive upper surface 412b, wherein adhesive lower surface 412a preferably adhesively contacts and secures a personal accessory thereto. Preferably, adhesive lower surface 412a provides secure positioning of pad 412 while maintaining subsequent removability through the utilization of removable adhesive product, such as, for exemplary purposes, removable adhesive sold under the trade name COMMAND. Preferably, a loop 414 is integrally formed with upper surface 412b of pad 412 and is preferably dimensioned to receive hooking means 420, as more fully described below. Furthermore, slits 412c and 412d are preferably formed through pad 412, wherein the distance between slits 412c and 412d is equivalent to the width of loop 414, and wherein the portion of lower surface 412a between slits 412c and 412d preferably possesses no adhesive to facilitate the reception of hooking means 420 therethrough, as more fully described below. Although mounting means 420 is preferably formed from a plastic material, other suitable material may be utilized, such as for exemplary purposes only, any pliable material and/or rigid material, if desired.

Hooking means 120 is preferably formed from an elongated, substantially flat plastic strip 422, wherein strip 422 has preferably circular-shaped first end 424a, second end 424b and shaped loop 426, wherein shaped loop 426 is preferably formed from strip 422 folding back onto itself, as more fully described below. Preferably, strip 422 is dimensioned to permit second end 424b to enter and pass through loop 414 of mounting means 410 and slits 412c and 412d of pad 412, wherein shaped loop 426 is preferably interlocked/situated within loop 414 of mounting means 410 and between slit 412c and 412d of pad 412. Although plastic is the preferred material of strip 422, other suitable material may be used, such as, for exemplary purposes only, fabrics and/or other pliable material.

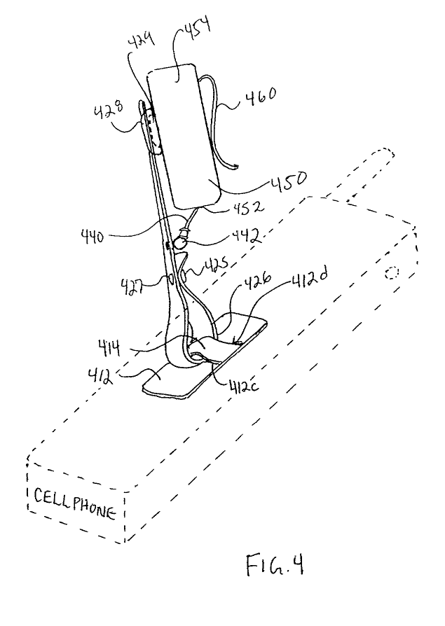

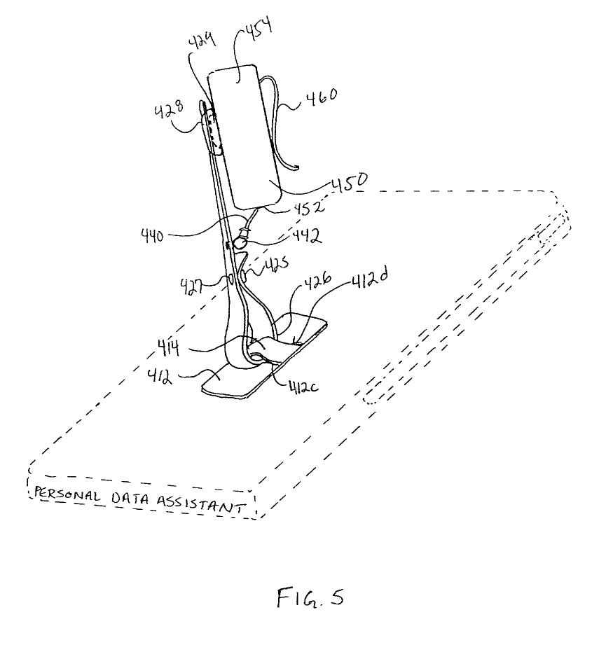

Attached preferably at second end 424b of strip 422 of hooking means 420 is snap button 425, wherein snap button 425 preferably engages snap receiver 427 positioned proximal the mid-region of strip 422. Snap button 425 and snap receiver 427 preferable engage in a snap-fit action as known within the art, thus preferably forming secured shaped loop 426. Similarly, attached preferably at first end 424a of strip 422 of hooking means 420 is snap button 428, wherein snap button 428 preferably engages snap receiver 429 positioned on front face 456a of outer surface 456 of housing 450, as more fully described below. Snap button 428 and snap receiver 429 preferable engage in a snap-fit action as known within the art and preferably function to allow the release and extension of a personal device therefrom via assistance from cable 440, wherein the personal article is adhesively secured to pad 412 of mounting means 410 and carried by interconnection of shaped loop 426 of hooking means 420 with loop 414 of mounting means 410, as best depicted in FIGS. 4-5.

Preferably, cable 440 is a flexible, plastic coated wire cable; although any other suitable wire may be utilized, such as, for exemplary purposes only, metal cable and/or nylon string. Second end 440b of cable 440 is fixed within housing 450, wherein cable 440 is resiliently wound, passing through housing aperture 452 in peripheral sidewall 454. Preferably, housing aperture 452 is substantially circular-shaped and preferably possesses aperture locking extension 452a defined therein and functioning as a stopping means. Aperture locking extension 452a is dimensioned to receive and retain cable 440 therein, thereby fixing the extended length of cable 440 and preventing the complete recession of cable 440 back into housing 450. Preferably, the resilient force urging first end 440a of cable 440 to return to housing 450 may be counterbalanced by the weight of a personal accessory attached to carrying device 400 coupled with minimal user resistance thereby allowing use of an attached personal device.

Rivet 442 of first end 440a of cable 440 is preferably affixed to strip 422 of hooking means 420 proximal to snap receiver 427, wherein rivet 442 is preferably ball-shaped and dimensioned larger than housing aperture 452 of housing 450 to preferably further assist in preventing the complete recession of cable 440 back into housing 450.

Housing 450 has a preferably substantially circular shaped, substantially flat outer surface 456, wherein outer surface 456 possesses front face 456a, rear face 456b and peripheral sidewall 454. Preferably positioned on front face 456a is snap receiver 429 for secured receipt of snap button 428 of mounting means 410 thereto, wherein snap button 428 is preferably removed from snap receiver 429 when a user of device 400 wishes to extend the attached personal device to a comfortable position via assistance from cable 440. Formed preferably on rear face 456b of housing 450 is slot 457 for receipt of clipping means 460 therein, as more fully described below.

Clipping means 460 is preferably formed from a substantially flat, substantially elongated rectangular shaped metal plate 461 having first end 462 and second end 464. First end 462 preferably extends through slot 457 of housing 450 and is preferably fixed within housing 450, wherein plate 461 extends therefrom and remains substantially flush against rear face 456b of outer surface 456 of housing 450. Plate 461 curves away from rear face 456b forming looped end 466, folding back on itself, extending substantially flat and at an angle to bend 468 wherein second end 464 curves away from first end 462. Preferably, second end 464 is rounded. Bend 468 is positioned proximate to rear face 456b of housing 450, wherein a user attaches clipping means 460 by sliding his or her belt, pocket or other clothing or personal article between second end 464 and rear face 456b of housing 450, thus enabling clipping means 460 to effectively grip the clothing area.

Referring now to FIGS. 4-5, in use, adhesive lower surface 412a of mounting means 410 is attached to a personal accessory. Second end 424b of hooking means 420 is then inserted through loop 414 and through slits 412c and 412d of mounting means 410, wherein second end 124b is then secured to snap receiver 427 via snap button 425 of second end 424b, thus creating shaped loop 426 and further securing the attached personal article. The personal accessory may be carried, hands-free, by attaching clipping means 460 to a user's belt, pocket or other clothing or personal article between second end 464 of clipping means 460 and rear face 456b of housing 450 thus enabling clipping means 460 to effectively grip the clothing article. To access and use the personal accessory, a user unsnaps snap button 427 from snap receiver 429 and pulls on the personal accessory secured to hooking means 420, thereby causing cable 440 to unwind. The resilient force urging cable 440 to return to housing 450 is counterbalanced by the weight of a personal accessory coupled with a minimal user resistance thereby permitting secure and comfortable access thereto. If desired, the user can effectively lock cable 440 in locking aperture extension 452a by inserting cable 440 therein, wherein cable 440 is held therein until removed by the user. With cable 440 in the unlocked position, if the user should forget to replace his or her personal accessory after use, the carrying device 400 automatically recoils cable 440, thus preventing accidental loss thereof.

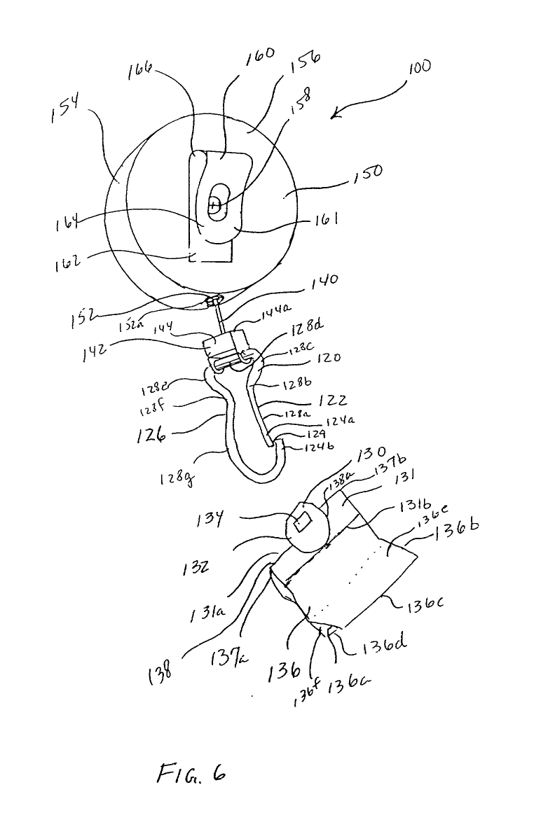

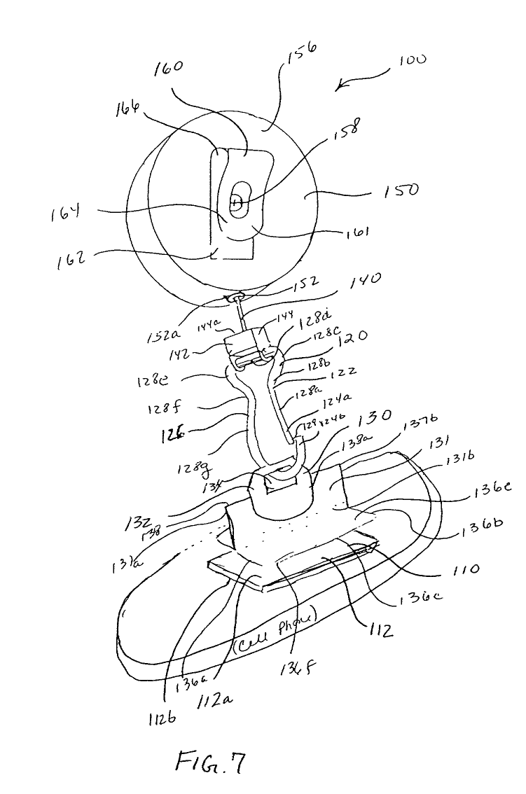

Referring now to FIGS. 6 and 7, in an alternate embodiment of the present invention, a personal accessory carrying device 100 comprises mounting means 110, hooking means 120, hook receiving means 130, cable 140, housing 150 and clipping means 160. Mounting means 110 is preferably a substantially flat, substantially rectangular shaped pad 112 having adhesive upper surface 112a and adhesive lower surface 112b. Preferably, adhesive lower surface 112b provides secure positioning of pad 112 while maintaining subsequent removability through the utilization of removable adhesive product, such as, for exemplary purposes, removable adhesive sold under the trade name COMMAND.

Hooking means 120 is preferably formed from an elongated, substantially flat shaped metal bar 122 wherein bar 122 has first end 124a, second end 124b and shaped loop 126. Preferably, bar 122 is dimensioned to permit second end 124b to enter and pass through hook receiving means 130. Preferably, shaped loop 126 is defined by bar 122 wherein substantially straight section 128a of bar 122 extends from first end 124a to first loop indentation 128b, extending outwardly to first loop arc 128c. Preferably, bar 122 extends from first loop arc 128c to loop base point 128d, extending therefrom to second loop arc 128e. Bar 122 preferably extends inwardly at an angle from second loop arc 128e to second loop indention 128f and therefrom arcuately extends to third loop arc 128g. Third loop arc 128g extends to second end 124b of bar 122, defining a substantially semicircular hook shape, wherein second end 124b extends past first end 124a thereby defining closure means 129.

Hook receiving means 130 is preferably a substantially flat, substantially rigid, substantially rectangular shaped plate 131 with first elongated edge 131a and second elongated edge 131b. Preferably, hook receiving extension 132 extends from the midpoint of first elongated edge 131a, wherein hook receiving extension 132 is preferably integral to plate 131 and wherein hook receiving extension 132 has aperture 134 centrally defined therein. Preferably, aperture 134 is dimensioned to receive second end 124b of bar 122 therethrough, thereby enabling removable attachment of personal accessory carrying device 100 to a personal accessory.

Preferably, plate 131 is positioned within flexible, sturdy fabric 136. Preferably, fabric 136 is substantially rectangular shaped with two long edges 136a and 136b, two short edges 136c and 136d, front surface 136e and rear surface 136f. Preferably, plate 131 is secured at midpoint 137a of long edge 136a, extending substantially parallel with short edges 136c and 136d to midpoint 137b of long edge 136b, wherein fabric 136 folds over plate 131 along the line of midpoint 137a and 137b defining edge 138. Preferably, edge 138 of fabric 136 defines opening 138a, wherein hook receiving extension 132 of plate 131 extends therethrough. Preferably, rear surface 136f of fabric 136 carries an adhesive whereby hook receiving means 130 is secured to mounting means 110.

Cable 140 is movably positioned along shaped loop 126 within connecting means 142. Preferably, connecting means 142 is a metal bracket 144 having a substantially square base 144a, two substantially square side walls 144b and 144c, and two connecting walls 144d and 144e. Base 144a defines a substantially circular shaped aperture wherein cable 140 passes therethrough and preferably, wherein bead 148 carried on first end 140a of cable 140 prevents return passage thereof. Connecting walls 144d and 144e are substantially rectangular shaped with substantially circular shaped aperture 146 defined therethrough wherein aperture 146 is dimensioned to allow unencumbered passage of bar 122 therethrough thereby connecting cable 140, via bracket 144, to loop 126.

Preferably, cable 140 is a flexible, plastic coated wire cable. Second end 140b of cable 140 is fixed within housing 150 wherein cable 140 is resiliently wound, passing through housing aperture 152 in peripheral sidewall 154. Preferably, housing aperture 152 is substantially circular shaped with aperture locking extension 152a defined therein, functioning as a stopping means. Aperture locking extension 152a is dimensioned to receive and retain cable 140 therein, thereby fixing the extended length of cable 140 and preventing the return of cable 140 to housing 150. Preferably, the resilient force urging first end 140a of cable 140 to return to housing 150 may be counterbalanced by the weight of a personal accessory attached to carrying device 100 coupled with minimal user resistance thereby allowing use of an attached personal device.

Housing 150 has a preferably substantially circular shaped, substantially flat outer surface 156 wherein screw 158 is preferably centrally located therein and clipping means 160 is carried thereby. Screw 158 provides accessible, secure closure to housing 150 and removable attachment of clipping means 160.

Clipping means 160 is preferably formed from a substantially flat, substantially elongated rectangular shaped metal plate 161 having first end 162 and second end 164. First end 162 is preferably fixed within housing 150 wherein plate 161 extends therefrom, proximate to outer surface 156, substantially flush thereagainst. Plate 161 curves away from outer surface 156 forming looped end 166, folding back on itself, extending substantially flat and at an angle to bend 168 wherein second end 164 curves away from first end 162. Preferably second end 164 is rounded. Bend 168 is positioned proximate to first end 162 without contact therewith, wherein a user attaches clipping means 160 by sliding his or her belt, pocket or other clothing or personal article between second end 164 and first end 162 of clipping means 160 and wherein clipping means 160 effectively grips the personal article.

In an alternate embodiment, hooking means 120 could be formed from a sturdy plastic.

In another alternate embodiment, cable 440 and/or 140 could be flexible metal cable, woven fibers or plastic.

In yet another alternate embodiment, connecting means 142 could be an eye assembly secured to first end 140a of cable 140 wherein the eye throughhole would be movably positioned along loop 126.

In still yet another alternate embodiment, metal bracket 144 could be formed from plastic.

In still another alternate embodiment, the resilient force urging first ends 440a and 140a of cables 440 and 140, respectively, of devices 400 and 100, respectively, to return to housing 450 and 150, respectively, could be adjustable.

In another alternate embodiment, housings 450 and 150 could be formed without aperture locking extensions 452a and 152a, respectively, wherein no stopping means would be provided.

In yet another alternate embodiment, cables 440 and 140 of devices 400 and 100, respectively, could be resiliently wound within respective housings 450 and 150, wherein upon unwinding of cables 440 and 140, respectively, to a specified length, an automatic stop mechanism could be engaged to block the resilient force urging cables 440 and 140 to return to housings 450 and 150, respectively, and wherein, at the user's discretion, additional unwinding of cables 440 and 140 could disengage the automatic stop mechanism, thereby releasing the resilient force urging cables 440 and 140 to return to respective housings 450 and 150.

In still another alternate embodiment, housings 450 and 150 could be of any geometric shape.

In yet still another alternate embodiment, housings 450 and 150 could be provided with a threaded closure mechanism to allow accessible, secure closure thereof.

In another alternate embodiment, clipping means 460 and 160 could be integral formed with housings 450 and 150, respectively.

In yet another alternate embodiment, clipping means 460 and 160 could be plastic.

In still another alternate embodiment, clipping means 460 and 160 could provide a spring-loaded clip mechanism.

In yet still another alternate embodiment, a multitude of indicia including, but not limited to, company logos and advertisements, licensed characters, and educational institution logos and advertisements may be imprinted on outer surface 136e of fabric 136 and/or housing 150 of device 100 and/or housing 450 of device 400.

In another alternate embodiment, mounting means 410 and 110 could be of any geometric shape.

In another alternate embodiment, upper surface 112a of mounting means 110 could carry hook and loop attachment means and bottom surface 136f of fabric 136 could carry complementary hook and loop attachment means, wherein hook attachment means 130 could be removably secured to mounting means 110, and thus to a personal accessory, thereby.

In still another alternate embodiment, carrying device 100 could include a specific mounting bracket having a hook receiving means, wherein said bracket could be secured to a case of a specific personal accessory, thereby replacing mounting means 110 and hook receiving means 130, wherein a plurality of mounting brackets could be available to permit utilization by a plurality of personal accessories.

In yet another alternate embodiment, mounting means 410 and 110 could be permanently attached to respective personal devices.

In yet still another alternate embodiment, hook receiving means 130 could be directly secured to a personal accessory wherein mounting means 110 would not be utilized.

In still another alternate embodiment, hooking means 120 could be formed as a known key ring type link, wherein hook receiving means 130 could be dimensioned to receive said key ring type link therethrough.

In another alternate embodiment, hooking means 120 could be carried by a personal accessory and carrying device 100 could have a hook receiving means, whereby a personal accessory is linked to carrying device 100 in reverse configuration from the preferred embodiment.

In yet another alternate embodiment, hook receiving means 130 could be a grommet, ring, hook or any other substantially closed receptacle means capable of retaining a clip, hook or securing ring therethrough.

In still another alternate embodiment, fabric 136 could be replaced with suitable plastic or metal, or other suitably strong material.

In use, adhesive lower surface 112b of mounting means 110 is attached to a personal accessory. Adhesive rear surface 136f of fabric 136 is attached to front surface 112a, thereby securing hook receiving means 130 to mounting means 110. Second end 124b of hooking means 120 is inserted through aperture 134 of hook receiving means 130, wherein second end 124b of hooking means 120 extends past first end 124a, thereby removably securing hooking means 120 around hook receiving means 130 and securing carrying device 100 to the selected personal accessory. The personal accessory may be carried, hands-free, by attaching clipping means 160 to a user's belt, pocket or other clothing or personal article between second end 164 and first end 162 of clipping means 160 and wherein clipping means 160 effectively grips the belt or pocket. To access and use the personal accessory, a user pulls on the personal accessory secured to hooking means 120, thereby causing cable 140 to unwind. The resilient force urging cable 140 to return to housing 150 is counterbalanced by the weight of a personal accessory coupled with a minimal user resistance thereby permitting secure and comfortable access thereto. If desired, the user can effectively lock cable 140 in locking aperture extension 152a by inserting cable 140 therein, wherein cable 140 is held therein until removed by the user. With cable 140 in the unlocked position, if the user should forget to replace his or her personal accessory after use, the carrying device 100 automatically recoils cable 140 preventing accidental loss thereof.

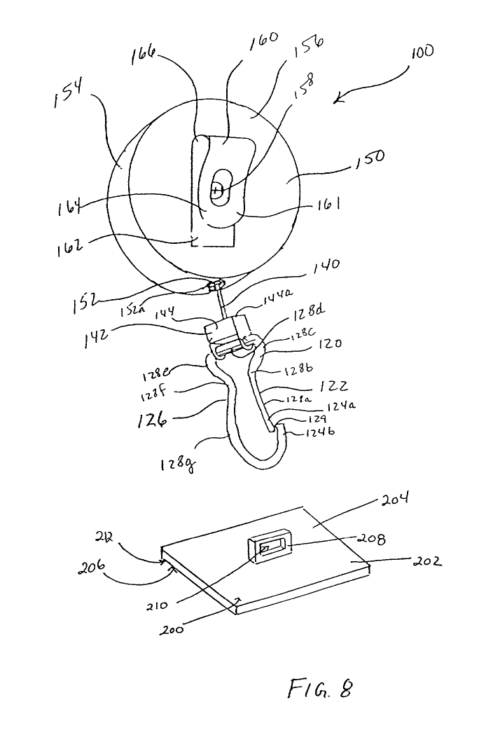

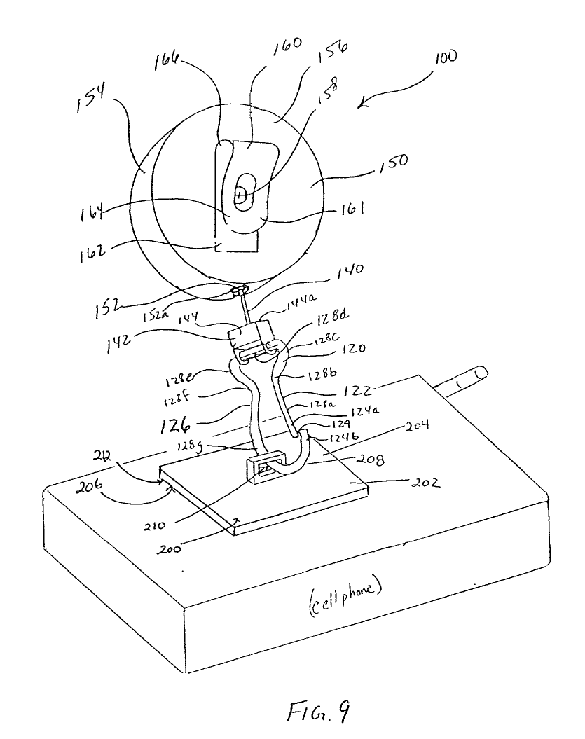

Referring now to FIGS. 8-9, it is contemplated in an alternate embodiment that mount 200 could be used to attach a personal device to hooking means 120, wherein mount 200 is a substantially rectangular shaped plate 202 having a top surface 204 and a bottom surface 206. Plate 202 could define other shapes, such as, for exemplary purposes only, circular. Top surface 204 has loop 208 positioned preferably centrally thereon, wherein loop 208 possesses aperture 210 dimensioned to receive second end 124b of bar 122 of hooking means 120. Loop 208 can be attached to top surface 204 via any attaching means known within the art, such as, for exemplary purposes only, adhesives, or may be integrally formed therefrom. Bottom surface 206 preferably has adhesive 212 affixed thereto for engaging the personal device to be carried. Adhesive 212 can be any suitable adhesive known within the art, such as, for exemplary purposes only, epoxy or tape. Mount 200 can be formed from any suitable material known within the art, such as, for exemplary purposes only, metal or plastic.

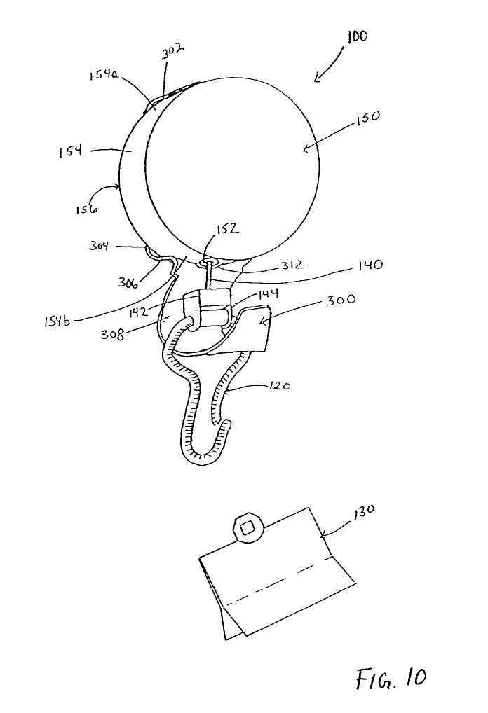

Referring now to FIGS. 10-13, it is contemplated in an alternate embodiment that device 100 as described in FIGS. 6-9 could comprise a catch hook 300 preferably removably attachable to housing 150 of device 100. Catch hook 300 is preferably metal with first grip portion 302 extending generally perpendicular to elongated portion 304, wherein second grip portion 306 extends generally perpendicularly from elongated portion 304. Preferably, hook 308 is substantially flat, generally V-shaped, and extends from second grip portion 306.

Elongated portion 304 preferably further comprises first slot 310 proximal to first grip portion 302. Second slot 312 is preferably defined within second grip portion 306 and hook 308, generally positioned at the intersection of second grip portion 306 and hook 308. The preferred length of elongated portion 304 enables placement of slot 310 over second end 164 of clipping means 160, wherein first grip portion 302 abuts area 154a of peripheral sidewall 154 of housing 150 and second grip portion 306 can be pushed against flat outer surface 156, thereby tensionly grasping and engaging area 154b of peripheral sidewall 154. Upon tensioned engagement of catch hook 300 with housing 150, slot 312 is positioned proximate to substantially circular housing aperture 152 on peripheral sidewall 154. Catch hook 300 preferably functions to prevent undesired extension of cable 140 by catching, holding and/or seating metal bracket 144 of connecting means 142 within surface 309 of hook 308.

Elongated portion 304 defines throughholes 303 and 305 thereby enabling catch hook 300 to be fixedly secured to flat outer surface 156 via any securing means known within the art, such as, for exemplary purposes only, screws, bolts or rivets.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A carrying device for facilitating transportation of a personal accessory, comprising:
a mounting means;
a hooking means;
a housing;
a resiliently wound cable; and
a clipping means for removably securing said carrying device to a user.

2. The carrying device of claim 1, wherein said mounting means is an adhesive pad capable of adhesively securing to a personal accessory.

3. The carrying device of claim 1, wherein said hooking means is a strip of material receivable by a loop formed on said mounting means, said hooking means forming a closed loop via a snap-fit mechanism carried by said hooking means, wherein said closed loop of said hooking means and said loop of said mounting means are interlocked with one another, and wherein said hooking means is removable from said loop of said mounting means via release of said snap-fit mechanism of said hooking means.

4. The carrying device of claim 3, wherein said hooking means is further removably secured to said housing via a snap-fit mechanism, said hooking means carrying the female member of said snap-fit mechanism and said housing carrying the male member of said snap-fit mechanism.

5. The carrying device of claim 4, wherein said resiliently wound cable is enclosed within said housing and extendable therefrom, said cable having a first end and a second end, said second end of said cable secured within said housing and said first end of said cable secured to said hooking means to allow resilient extension of said hooking means and the secured personal accessory from said housing upon release of said female member of said snap-fit mechanism of said hooking means from said male member of said snap-fit mechanism of said housing.

6. The carrying device of claim 1, wherein said clipping means is a resilient clip carried by said housing and removably securable to a user of said carrying device.

7. The carrying device of claim 1, wherein said hooking means is a hook having a resilient closure arm, said hook capable of being hooked to a hook receiving means, wherein hook receiving means is a plate having an aperture formed therethrough for receipt of said hook, said plate being adhesively joined to an adhesive mounting member, said mounting member being adhesively joined to a personal accessory.

8. The carrying device of claim 7, wherein said hooking means is carried by said cable.

9. The carrying device of claim 1, further comprising a catch hook carried by said housing, said catch hook serving as a buttress for said hooking means and as a preventive measure against unwanted extension of said cable due to heavy weighted personal accessories carried by said hooking means.

10. A carrying device for facilitating transportation of a personal accessory, comprising:
a hooking means for removably securing said carrying device to a personal accessory;
a mounting means for receiving said hooking means, said mounting means capable of adhering to a personal accessory;
a housing;
a resiliently wound cable enclosed within said housing; and
a clipping means carried by said housing for removably securing said carrying device to a user.

11. The carrying device of claim 10, wherein said mounting means is an adhesive pad capable of adhesively securing to a personal accessory.

12. The carrying device of claim 10, wherein said hooking means is a strip of material receivable by a loop formed on said mounting means, said hooking means forming a closed loop via a snap-fit mechanism carried by said hooking means, wherein said closed loop of said hooking means and said loop of said mounting means are interlocked with one another, and wherein said hooking means is removable from said loop of said mounting means via release of said snap-fit mechanism of said hooking means.

13. The carrying device of claim 12, wherein said hooking means is further removably secured to said housing via a snap-fit mechanism, said hooking means carrying the female member of said snap-fit mechanism and said housing carrying the male member of said snap-fit mechanism.

14. The carrying device of claim 13, wherein said resiliently wound cable is enclosed within said housing and extendable therefrom, said cable having a first end and a second end, said second end of said cable secured within said housing and said first end of said cable secured to said hooking means to allow resilient extension of said hooking means and the secured personal accessory from said housing upon release of said female member of said snap-fit mechanism of said hooking means from said male member of said snap-fit mechanism of said housing.

15. The carrying device of claim 10, wherein said clipping means is a resilient clip carried by said housing and removably securable to a user of said carrying device.

16. The carrying device of claim 10, wherein said hooking means is a hook having a resilient closure arm, said hook capable of being hooked to a hook receiving means, wherein hook receiving means is a plate having an aperture formed therethrough for receipt of said hook, said plate being adhesively joined to an adhesive mounting member, said mounting member being adhesively joined to a personal accessory.

17. The carrying device of claim 16, wherein said hooking means is carried by said cable.

18. The carrying device of claim 10, further comprising a catch hook carried by said housing, said catch hook serving as a buttress for said hooking means and as a preventive measure against unwanted extension of said cable due to heavy weighted personal accessories carried by said hooking means.
